(19) United States
(12) Patent Application Publication
(10) Pub. No.: US 2006/0283718 A1
(43) Pub. Date: Dec. 21, 2006

(54) Reactor loop for producing hydroxyl water

(76) Inventor: Rudy Schreppel JR., Broken Arrow, OK (US)

Correspondence Address: RUDY SCHREPPEL . JR, 525 S LAUREL AVE., BROKEN ARROW, OK, 74012, US

(21) Appl. No.: 11/156,642

(22) Filed: Jun. 21, 2005

(51) Int. Cl. C02F 1/461

(52) U.S. Cl. 205/742

(57) ABSTRACT

A method and apparatuses for producing hydroxyl water for the use in remediation of soil, groundwater, or polluted liquid wherein liquid is pumped under pressure into a series of conduits with internal baffle plates with a plurality or openings connected by u-shaped connectors thus causing a multiplicity of jets of liquid to issue from openings within the baffles wherein liquid is additionally bombard with the surface tension the copper-nickel surface of the inner wall and the baffles thus producing a condition wherein freed electrons produce hydroxyl water.

This application claims priority from provisional application No. 60/577,927 filed on Jun. 9, 2004.

### BACKGROUND OF THE INVENTION

The contamination of soil and water has been a problem for decades. Prior attempts to decontaminate soil have variously included excavating the contaminated soil and processing it or otherwise washing the soil with surfactant chemicals and/or pH adjusters to remove soil contaminants, and returning the cleansed soil to the site or in some cases thermally processing the soil through incineration.

Decontaminating water can also be extremely difficult. In some cases, contaminated water or underground aquifers, remediation is so difficult that a economical solution is very difficult to identify. In some instances, groundwater is treated with conventional filtration methods such as charcoal absorber beds or oil/water separators. Another option involves in-situ treatment in which chemicals are introduced into the water and react with the contaminants utilizing bio-remediation technology.

In recent technology, decontamination of water using ion exchange has produced novel methods to rid water of contaminants in an economical manner. Many of the currently employed methods for decontamination of water and soils involve some form of diffusion-controlled ion exchange working with additional processes to clean the soil or water. A growing method of remediation now includes ion exchange in one form or another.

For example, one of the world's largest plants for treatment of effluent from a spent nuclear fuel plant is the British Nuclear Fuels, Inc., SIXEP Plant. The SIXEP process is based on ion exchange using an inorganic ion exchanger. In this process, the positively charged cesium and strontium ions are taken up into the crystal lattice of clinoptilolite, in preference to the sodium ions which are naturally present. In this process, water containing the radioactive ions is caused to pass into close proximity to the clinoptilolite, whereupon diffusion takes place to cause migration of the radioactive ions into the clinoptilolite lattice, displacing the sodium ions.

One feature of the present invention incorporates the use of ion exchange and it's benefits by producing hydroxyl water for more efficient remediation. More specifically, hydroxyl water for the use of separating solid or liquid particles pollutants from a liquid stream.

Existing known techniques for separating solid or liquid particles from a liquid-based mixture or emulsion include decanting where liquids may have different specific gravity. Oil and water are a good example of liquids with different specific gravity. It is typically known that hydroxyl water make this process work with more efficiently.

Another known process for removing pollutants is centrifuging. Pollutants can be separated from liquids by spinning said liquids in a rotating chamber whereby the heavier particles are separated by centrifugal force. Another method may be distillation. Distillation involves boiling the liquid and condensing the vapor. Distillation requires massive amounts of energy and is inefficient when the specific gravity of the liquid are close together.

The invention utilizes novel scientific principles to create ionization of the liquid stream. When the liquid stream is put under pressure into the invention, the metal construction within the invention tends to give up electrons which combine with the liquid molecules and with the particle molecules causing the similarly charged liquid and particles to repel and separate from each other.

A secondary action is utilized by the other materials, which may include copper or other metal, that will readily give up electrons to act as a catalyst to enhance the liquid stream propensity to surrender electrons when passed through the invention.

### BRIEF SUMMARY OF THE INVENTION

A cylinder like conduit contains a multiplicity of spaced baffles positioned at an angle to be determined per application. Said baffles lining the longitudinally extended walls from entrance to exit end of the cylinder in a perpendicular manner. The entry end of the cylinder may have a filter screen into the conduit when needed. The liquid is pumped under pressure into the conduit causing turbulence and a multiplicity of streams or jets to issue from the baffle openings and causing fluids to bombard the inner surface conduit and the baffles and to exchange ions.

Conduit and baffles may be made of copper, nickel, or other like metals for the purpose of assisting in the production of hydroxyl water or fluids within the conduit. Conduit may be made of a copper-nickel alloy or, preferably, the outer pipe is made of a ferrous metal and the inner surface of the outer pipe is flame coated with a copper-nickel alloy.

This invention provides new methods and apparatuses for producing hydroxyl water for the use in remediation of soil, groundwater, or polluted liquid. The hydroxyl water, being important to accomplish efficient remediation of water and the decontamination of large areas of land.

This invention furthermore incorporates within its design the use of mechanical pressure, cavitation, and catalyst processes to induce a negative charge in the medium and to force dissimilar bonds to separate.

The combination of simultaneous reactions utilized within this system affect the molecular structure and the positive and negative charge of the liquid medium in a method that produces greater oxidation efficiencies and enhanced molecular homogeneity. The process utilizes advanced technology that affects either clean water or the molecular structure of contaminated liquid by influencing the molecular charge of the organic substance that can be either fluid, gas, liquid or solid.

The invention offers new and unique processes offering improved cost and time efficient methods for high volume remediation processing that will revolutionize the environmental industry. The invention can speed up the remediation process and save thousands of dollars per site.

The foregoing and other objectives, features, and advantages of the invention will be more readily understood upon the consideration of the following detailed description of the invention.

### BRIEF DESCRIPTION OF THE DRAWINGS

FIG. 1 is a cross-sectional plan view taken through the center of the invention.

FIG. 2 is an end view taken along line A-A of FIG. 1.

FIG. 3 is a cross-sectional view taken along line B-B of FIG. 1.

### DETAILED DESCRIPTION OF THE PREFERRED EMBODIMENTS

This invention provides new and novel methods and apparatuses for producing hydroxyl water for the use in remediation of soil, groundwater, and polluted liquids. In basic terms, the processes of this invention generally involve causing ions to migrate under an externally applied pressures and the utilization of cavitation while being passed through a conduit wherein baffles and conduit material further trigger the release and exchange of ions thereby producing hydroxyl water.

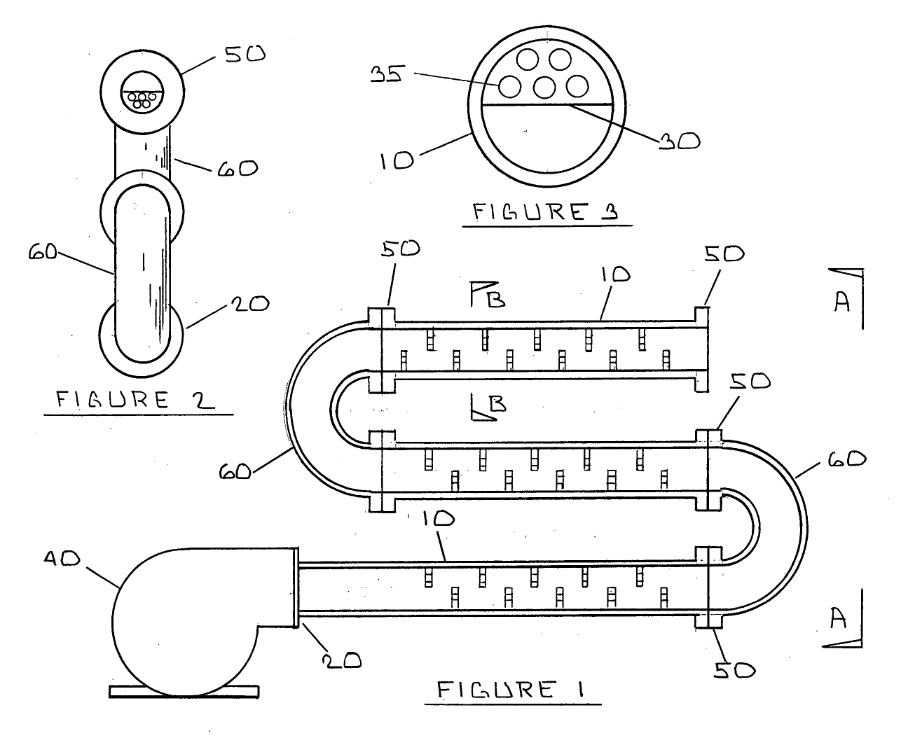

FIG. 1 is a cross sectional diagram of the preferred method for the production of hydroxyl water wherein untreated water is introduced into a conduit 10 comprising a concentric elongated cylindrical metal pipes or like conduit via inlet 20. Each pipe may be made of copper-nickel alloy or, made of a ferrous metal with the inner surface of the outer pipe flame coated with a copper-nickel alloy.

Wherein the untreated water is pumped from one or more feed pumps 40. The feed pumps shall pump water into inlet 20 at a pressure or such force to produce strong turbulence. Wherein the untreated water shall be passed through and around the multiplicity of baffles 30 for the process of diffusion-controlled ion exchange.

Feed pump 40 may be additionally supplied with a special impeller constructed of an alloy of nickel and copper and or metals. Wherein the fluid passing into conduit 10, via inlet 20, are already excited and exchanging ions within the pumping process. Said process consisting of a pre-process.

The fluids passing over, around, and through the baffles 30 shall cause a multiplicity of jets thereby creating ionization of the liquid stream. Liquid stream under such pressure to cause fluids to give up and exchange electrons which and produce hydroxyl water.

Said wall of the conduit 10 contains a multiplicity of spaced baffles 30 with radially bored holes 35 as indicated in FIG. 3 located throughout the proximity of the baffle surface area. The entry end of conduit 10 is joined to an inlet flange 20 for connection or engagement to a pump 40, the exit end of conduit 10 is affixed with a similar or like flange 50.

Flange 50 attached by any suitable means to circular shaped elongated cylindrical metal pipes or like conduit 60 having a u shaped configuration with similar or like flanges 50 attached wherein attachment means are on the same plane for the purpose of attaching a series of conduit 10 in series.

The liquids having been treated in conduit 10 are then passed through U-shaped conduit 60 and may also act as a deceleration means. The function of the deceleration is to create an abrupt decrease in the momentum of the stream exiting from conduit 10. Said action increasing turbulence and energy within the fluids.

Said u shaped connectors 60 allowing for an imbricate configuration within the series of conduits 10. Said conduits 10 each having an inlet flange 20 and an outlet flange 50 wherein each outlet flange is attached to a u-shaped conduit 60 with complementary flanges affixed for engagement purposes.

Said u shaped conduit connector 60 allowing for stacked series arrangements of the conduit 10 which may be adjustable in height and width based upon the angle in which the u shaped conduits are affixed or otherwise connected.

For best results the sum of the cross-sectional areas of the multiplicity of baffles 30 should equal or, preferably, grater than the cross-sectional area of inner conduit 10 in order to prevent any back pressure or flow restriction during operation. Moreover, the jet velocity, that is, the velocity of the liquid or gas jets it exits from the outlet flange 50 should be at least 0.025 feet (0.0076 m) per second. One formula for computing the jet velocity in feet (m) per second of the liquid or gas existing from outlet 50 is 4,085 times the gallons (3.785 liters) per minute divided by the square of the diameter of hole in flange outlet 50.

Hydroxyl water used in boilers reduces its boiling point and, thus, the energy required to convert the water into steam. Hydroxyl water is also a soft water, reducing or eliminating the need for water-softening chemicals, and inhibits the formation of scale and removes existing scale. In addition, hydroxyl water prevents corrosion in boiler tubes or like equipment by inducing an anode to act more like a cathode.

Furthermore hydroxyl water used in irrigation penetrates the soil, creating an ion exchange in the soil resulting in a breakdown of salts in the soil which prevents tip burn and salt poisoning in plants and trees while at the same time enhancing the plants' ability to absorb nutrients from the soil and fertilizers. When irrigation run-off water is treated, any nitrates and phosphates that have been introduced by fertilizers will be broken down thereby reducing the contaminating effects of run-off on stream, rivers and estuary waters.

Terms and expressions which have been employed in the forgoing specifications are used therein as terms of description and not of limitation, and there is no intention in the use of such terms and expressions of excluding equivalents of the features shown and described or portions thereof.

What I claim as my invention is:

1. A new method and apparatuses for producing hydroxyl water for the use in remediation of soil, groundwater, or polluted liquid wherein the untreated water or contaminated fluid is passed through a conduit affixed with a multiplicity of baffles spaced perpendicularly within the conduit with each baffle having a plurality of openings wherein conduit and baffles are constructed of a material promoting exchange of ions within the fluids passing through conduit thus producing hydroxyl water wherein said conduit is attached is series via u-shaped connectors.

2. The method of claim 1, wherein baffles are placed at variable degrees and angles within the inner wall of the conduit.

3. The method of claim 1, wherein baffles are placed at different configurations within the inner wall of the conduit so that spacing is non-uniform.

4. The method of claim 1, wherein a pump means incorporates a impeller produced of materials that will promote ion exchange.

5. The method of claim 1, wherein u-shaped connectors have internal veins to increase turbulence within the connection chamber.

6. The method of claim 1, wherein a helix of copper or copper-nickel alloy wire is wrapped within the inner conduit of the u-shaped connector.

7. The method of claim 1, wherein baffles are placed within the conduit to create a circular form of placement within the conduit.

8. The method of claim 1, wherein the baffles openings are of different sizes upon the same baffle.

9. The method of claim 1, wherein the baffles openings are of different sizes upon the different baffles.

10. The method of claim 1, wherein the flanges are replaced with welded connections.

11. The method of claim 1, wherein the flanges are replaced with screwed connections.

12. The method of claim 1, wherein baffles within the conduit are sized differently.

13. The method of claim 1, wherein the sum of the cross-sectional areas of the plurality of holes in the wall of the elongated cylindrical chamber is greater than the cross-sectional area of the elongated cylindrical chamber.

14. The method of claim 1, wherein a first elongated metal pipe having an entry end and an exit end shall not have baffles.

15. The method of claim 1, wherein the baffles are attached to a centrally disposed rod not attached to conduit.

16. The method of claim 1, wherein the baffles are attached to multiple rods not attached to conduit.

17. The method of claim 1, wherein the baffles are attached to a centrally disposed plate not attached to conduit.

18. The method of claim 1, wherein the baffle is a centrally disposed plate inserted within conduit wherein plate has cutout tangs bent up to create desired effect.
